(19) United States
(12) Patent Application Publication
(10) Pub. No.: US 2004/0142053 A1
(43) Pub. Date: Jul. 22, 2004

(54) Method and system for molding low density polymer articles

(76) Inventors: Algis P. August, Mississauga (CA); Casey P. August, Riverside, CT (US)

Correspondence Address: CASEY P. AUGUST, 360 RIVERSIDE AVE,, RIVERSIDE, CT, 06878, US

(21) Appl. No.: 10/756,981

(22) Filed: Jan. 14, 2004

Related U.S. Application Data
(60) Provisional application No. 60/440,233, filed on Jan. 14, 2003.

(51) Int. Cl. B29C 45/00

(52) U.S. Cl. 425/4 R; 425/547; 425/552; 425/817 R

(57) ABSTRACT

High quality articles which are large or of complex shapes are difficult to mold from low density expandable thermoplastic polymers, such as LDPP (Low Density PolyPropylene) because their low heat capacity density causes premature cooling and setting as they try to reach extremities and narrow regions of an injection mold cavity. To overcome these problems the invention provides cycling, during article production, of heating and cooling in the regions of the mold that are near these extremities and narrow regions. The resulting system offers production of low material cost polymer articles in lower cost, lower pressure injection molds and machine systems.

### BACKGROUND OF THE INVENTION

The present invention relates to systems and methods for molding low density (“foam”) articles from expandable polymers by injection molding from an extruder. More particularly, the invention is directed to systems and methods which enable injected expandable polymers to completely fill the extremities and narrow regions of a molding cavity.

The invention is intended for use with thermoplastic polymers, including polypropylene, polystyrene, polycarbonate (e.g. as sold under LEXAN, trademark of the General Electric Company, ABS (acrylonitrile-butadiene-styrene), polyethylene, and the like. For use in the present invention, it shall be understood that an “expandable” polymer comprises a polymer together with a blowing agent, such as pentane, which may be admixed with polymer granules before or during plastication in an extruder. A system incorporating an extruder and mold for injection of thermoplastic solid (non-expandable) polymers is succinctly described in U.S. Pat. No. 3,721,512, issued to Ma et al on Mar. 20, 1973, which is directed to control of the temperature and other parameters of the polymer during its transit through an extruder before injection into a costly, thick steel mold of a high pressure injection molding machine.

In order to use such an injection molding system for producing large or complex articles (which have narrow regions and extremities, such as corners, of a molding cavity to be filled with injected material) a high cost of material must result whenever solid thermoplastic polymers are used.

The use of expandable polymers for injection molding to produce such articles, while using less polymer material, entails other difficulties, including incomplete filling and defects in the aforesaid extremities and narrow regions. It is believed that these problems arise because a shot of expanding, foam polymer has insufficient caloric value (heat capacity density) to overcome the cooling effect of the thick-walled, high heat capacity of the (costly) machined steel mold into which the shot is injected by an extruder. As a result, the leading surface portion of the injected shot of expandable polymer cools and sets too rapidly to permit complete filling of narrow regions and extremities (e.g. corners) of the molding cavity. Moreover, it is believed that this effect is especially pronounced in the case of larger articles to be molded, where uniformity of temperature throughout the large mass of the injected shot is highly desirable to avoid the development of defect causing thermal stresses during the molding process.

The present invention proposes to overcome these difficulties while producing lower cost large or complex articles from an expandable thermoplastic polymer in a low cost mold.

### SUMMARY OF THE INVENTION

As discussed above, high quality articles which are large or of complex shapes are difficult to mold from low density expandable thermoplastic polymers, such as LDPP (Low Density PolyPropylene) because their low heat capacity density causes premature cooling and setting as they try to reach extremities and narrow regions of a an injection mold cavity. To overcome these problems the invention provides cycling, during article production, of heating and cooling in the regions of the mold that are near these extremities and narrow regions. The resulting system offers production of low material cost polymer articles in lower cost, lower pressure injection molds and machine systems.

The invention broadly provides a system for molding articles of low density polymer selected from polypropylene, polystyrene, ABS, and polyethylene, the afore said system comprising:

a) a mold comprising a plurality of mold elements which are relatively movable between a closed position, for forming an enclosed cavity defining the shape of a the article, and an open position, for permitting removal of a the article formed in the aforesaid enclosed cavity, at least one of the elements comprising a heating device for applying heating, during molding of the aforesaid article, and a cooling device for applying cooling thereafter, to set the aforesaid article, to at least one region of the aforesaid enclosed cavity, the aforesaid mold comprising an injection orifice permitting injection therethrough of a preselected quantity (“shot”) of expandable polymer into the aforesaid enclosed cavity;

b) an extruder operable to extrude the aforesaid shot of expandable polymer into said enclosed cavity through the injection orifice, the aforesaid shot comprising heated polymer and a blowing agent operable to cause expansion thereof;

c) a heat source operable to supply a heating fluid to the aforesaid heating device; and

d) a cooling source operable to supply a cooling fluid to the aforesaid cooling device.

Preferably, the the aforesaid at least one of the mold elements is thermally conductive, thin-walled of a low cost material (e.g. aluminum) to offer an advantageously low heat capacity, the aforesaid heating device and the aforesaid cooling device comprising a fluid passageway disposed within at least one of said mold elements. Advantageously, the fluid passageway is located at extremities and narrow regions of the enclosed cavity.

According to a preferred embodiment, the aforesaid system further comprises a valve connected to the aforesaid heat source, the aforesaid cooling source, and the aforesaid fluid passageway, the aforesaid valve being operable to transmit heating fluid to the aforesaid fluid passageway during molding of the article, the aforesaid valve being operable to transmit cooling fluid to the aforesaid fluid passageway during setting of the article into its final molded form.

The invention also broadly provides a method for molding an article from expandable polymer in a mold, the aforesaid expandable polymer comprising a polymer, selected from, and a blowing agent, the aforesaid mold comprising a plurality of mold elements each having a molding surface, the aforesaid mold elements being relatively movable between a closed position in which the molding surfaces together define a molding cavity for forming the article, and an open position that permits removal of the aforesaid article, the aforesaid method comprising the steps of:

a) closing the aforesaid mold elements to form the aforesaid molding cavity; b) filling the aforesaid molding cavity by injecting a preselected quantity (“shot”) of the aforesaid expandable polymer from an extruder;

c) heating at least extremities and narrow regions of molding surfaces of the aforesaid molding cavity to promote expansion and flow of the aforesaid shot of expandable polymer throughout the aforesaid molding cavity to form the aforesaid article;

d) then cooling the aforesaid molding surfaces to cause the expanded polymer to set in substantially the form of the aforesaid molding cavity.

According to a preferred embodiment, each aforesaid mold element is thermally conductive and has a fluid passageway therein and near the aforesaid extremities and narrow regions, and step (c) is carried out by injecting a heating fluid (e.g. steam) into the aforesaid fluid passageway.

Preferably, the aforesaid heating step (c) is switched to the aforesaid cooling step (d) by switching a valve connected to a heat source, a cooling source, and the aforesaid fluid passageway, the aforesaid valve being operable to transmit heating fluid to the aforesaid fluid passageway during molding of said article, the aforesaid valve being operable to transmit cooling fluid to the aforesaid fluid passageway during setting of the aforesaid article.

The invention further provides an injection molded article formed by extrusion into an injection mold from expanded low density thermoplastic polymer selected from polypropylene, polystyrene, polycarbonate, ABS, and polyethylene, and a blowing agent, the aforesaid article comprising extremities and narrow regions which are substantially free of thermal stress defects, incomplete formation of the aforesaid extremities and narrow regions, and distortions. Preferably, the expandable low density polymer is LDDP (low density polypropylene).

### BRIEF DESCRIPTION OF THE DRAWINGS

FIG. 1 is a schematic view of a system in accordance with the invention for molding articles of low density polymer, such as expandable polypropylene, to show the arrangement of the system components.

### DETAILED DESCRIPTION

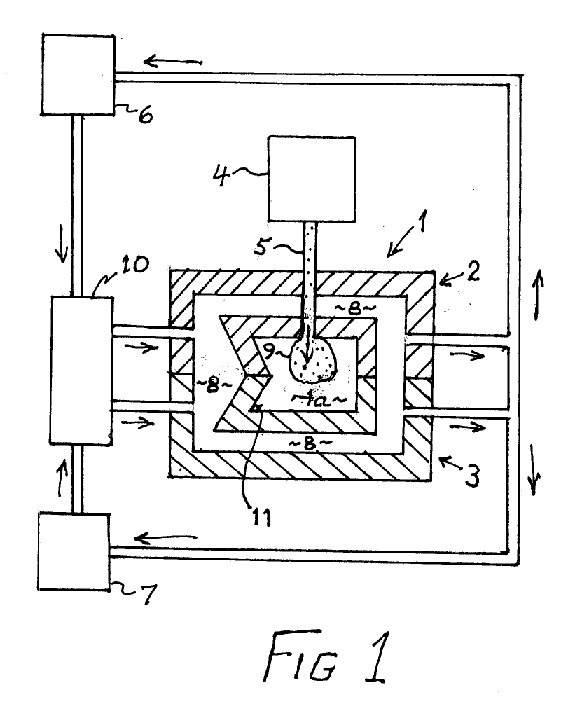

A preferred embodiment of the system of the present invention is schematically depicted in FIG. 1, in which a mold 1 comprises a plurality of two mold elements 2, 3, which are relatively movable between a closed position (as shown in FIG. 1), for forming an enclosed cavity 1a defining the shape of an article, and an open position, for permitting removal of the article formed in enclosed cavity 1a. Mold elements 2,3 may advantageously be made with low heat capacity from high thermal conductivity material (e.g. aluminum) and may be of moderate wall thickness because the pressure caused by expandable polymer is considerably less than pressures caused by injected solid polymers.

Both of mold elements 2, 3 comprise fluid passageway 8, which serves as both a heating device for applying heating, during molding of said article, and a cooling device for applying cooling thereafter, to set said article. While fluid passageway is shown surrounding the enclosed molding cavity 1a, it is important to dispose passageway 8 near at least the narrow region 11 of cavity 1a to achieve proper flow and filling with low heat capacity expandable polymer (e.g expandable polypropylene or LDPP—Low Density PolyPropylene). Mold 1 also comprises an injection orifice 5 permitting injection therethrough of a preselected quantity (“shot”) 9 of expandable polymer into enclosed molding cavity 1a

As shown in FIG. 1, an extruder 4 is operable to extrude shot 9 of expandable polymer into said enclosed cavity 1a through injection orifice 5. As will be understood, shot 9 comprises polymer heated during its passage through extruder 4, together a blowing agent which has been admixed as a powder or fluid or otherwise incorporated into the polymer to cause expansion thereof;

In the illustrated embodiment, a heat source 6 is operable to supply a heating fluid such as heated steam or water to the heating device (in the form of fluid passageway 8), and a cooling source 7 is operable to supply a cooling fluid (e.g. cooled ethylene glycol or water) to the cooling device (in the form of the fluid passageway 8).

Advantageously, the inventive system further comprises a valve 10 which is connected for fluid communication with heat source 6, cooling source 7, and fluid passageway 8. The arrows in FIG. 1 denote the direction of fluid flows in the system as the molding method of the invention is carried out. Valve 10 is operable to transmit heating fluid to fluid passageway 8 during molding of the low density foam article to prevent cooling and poor flows and thermal stresses in leading portions of shot 9 as they try to flow into extremities (e.g. 11) and narrow regions of cavity 1a. After the article is so formed, valve 10 is switched to cooling mode to transmit cooling fluid from cooling source 7 to fluid passageway 8 during setting of said article into its hardened permanent form.

The method of the present invention with reference to FIG. 1 comprises the steps of:

a) closing mold elements 2,3 to form molding cavity 1a;

b) filling molding cavity 1a by injecting a preselected quantity (“shot”) 9 of the expandable polymer from an extruder 4 through orifice 5;

c) heating at least extremities and narrow regions, such as region 11, of molding cavity 1a to promote expansion and flow of shot 9 throughout molding cavity 1a to form the article, which may advantageously be large (e.g. outdoor article, mailbox, drop-box, industrial furniture, tote, or the like); and

d) then cooling the molding surfaces of mold elements 2,3 to cause the expanded polymer to set in substantially the form of molding cavity 1a.

As shown, each mold element 2, 3 is thermally conductive and of low heat capacity (e.g. thin walled aluminum, preferably formed in an inexpensive manner by use of sand-molding) and has a fluid passageway 8 therein and near the aforesaid extremities and narrow regions (e.g. 11), and wherein step (c) is carried out by injecting a heating fluid (e.g. steam) into fluid passageway 8.

Heating step (c) can be switched to said cooling step (d) by switching valve 10 which is shown to be connected to heat source 6, cooling source 7, and fluid passageway 8. Valve 10 is operable to transmit heating fluid to fluid passageway 8 during molding of the foam article, thereby preventing cooling of shot 9 as it tries to expand into extremities and narrow regions (e.g. 11) of cavity 1a. Subsequently, valve 10 is operable to transmit cooling fluid to fluid passageway 8 during setting of the finished article.

Although illustrative embodiments of the invention have been described herein, it will apparent to persons skilled in the polymer molding field that changes and modifications can be made without departing from the scope and spirit of the present invention as set forth in the appended claims.

What is claimed is:

1. A system for molding articles of low density polymer selected from polypropylene, polycarbonate, polystyrene, ABS, and polyethylene said system comprising:
a) a mold comprising a plurality of mold elements which are relatively movable between a closed position, for forming an enclosed cavity defining the shape of a said article, and an open position, for permitting removal of a said article formed in said enclosed cavity, at least one of said mold elements comprising a heating device for applying heating, during molding of said article, and a cooling device for applying cooling thereafter, to set said article, to at least one region of said enclosed cavity, said mold comprising an injection orifice permitting injection therethrough of a preselected quantity (“shot”) of expandable polymer into said enclosed cavity;
b) an extruder operable to extrude said shot of expandable polymer into said enclosed cavity through said injection orifice, said shot comprising heated polymer and a blowing agent operable to cause expansion thereof;
c) a heat source operable to supply a heating fluid to said heating device; and
d) a cooling source operable to supply a cooling fluid to said cooling device.

2. A system for molding articles of low density polypropylene, said system comprising:
a) a mold comprising a plurality of mold elements which are relatively movable between a closed position, for forming an enclosed cavity defining the shape of a said article, and an open position, for permitting removal of a said article formed in said enclosed cavity, at least one of said mold elements comprising a heating device for applying heating, during molding of said article, and a cooling device for applying cooling thereafter, to set said article, to at least one region of said enclosed cavity, said mold comprising an injection orifice permitting injection therethrough of a preselected quantity (“shot”) of expandable polypropylene into said enclosed cavity;
b) an extruder operable to extrude said shot of expandable polypropylene into said enclosed cavity through said injection orifice, said shot comprising heated polypropylene and a blowing agent operable to cause expansion thereof;
c) a heat source operable to supply a heating fluid to said heating device; and
d) a cooling source operable to supply a cooling fluid to said cooling device.

3. A system as set forth in claim 2, said at least one of said mold elements being thermally conductive, said heating device and said cooling device comprising a fluid passageway disposed within said at least one of said mold elements.

4. A system as set forth in claim 3, said system further comprising a valve connected to said heat source, said cooling source, and said fluid passageway, said valve being operable to transmit heating fluid to said fluid passageway during molding of said article, said valve being operable to transmit cooling fluid to said fluid passageway during setting of said article.

5. A system as set forth in claim 3, said fluid passageway being disposed at extremities and narrow regions of said enclosed cavity.

6. A system as set forth in claim 4, said fluid passageway being disposed at extremities and narrow regions of said enclosed cavity.

7. A method for molding an article from expandable polymer in a mold, said expandable polymer comprising a polymer, selected from polypropylene, polystyrene, polycarbonate, ABS, and polyethylene, and a blowing agent, said mold comprising a plurality of mold elements each having a molding surface, said mold elements being relatively movable between a closed position in which the molding surfaces together define a molding cavity for forming the article, and an open position that permits removal of said foam article, said method comprising the steps of:
a)i) heating said molding surfaces by conduction through said mold elements; and
a)ii) closing said mold elements to form said molding cavity;
b) after closing step (a)(ii), filling said molding cavity by injecting a preselected quantity (“shot”) of said expandable polymer from an extruder;
c) heating at least extremities and narrow regions of said molding cavity to promote expansion and flow of said shot of expandable polymer throughout said molding cavity to form said article;
d) then cooling said molding surfaces to cause the expanded polymer to set in substantially the form of said molding cavity.

8. A method as set forth in claim 7, wherein each said mold element is thermally conductive and has a fluid passageway therein, and wherein step (a)(i) is carried out by injecting a heating fluid steam into said fluid passageway.

9. A method as set forth in claim 8, wherein said heating step (c) is switched to said cooling step (d) by switching a valve connected to a heat source, a cooling source, said fluid passageway, said valve being operable to transmit heating fluid to said fluid passageway during molding of said article, said valve being operable to transmit cooling fluid to said fluid passageway during setting of said article.

10. An injection molded article formed by extrusion into an injection mold from expanded low density thermoplastic polymer selected from polypropylene, polystyrene, polycarbonate, ABS, and polyethylene, and a blowing agent, said article comprising extremities and narrow regions which are substantially free of thermal stress defects, incomplete formation of said extremities and narrow regions, and distortions.

11. An injection molded article as set forth in claim 10, said expandable low density polymer being LDDP (low density polypropylene).
